(19) United States
(12) Patent Application Publication
(10) Pub. No.: US 2016/0170545 A1
(43) Pub. Date: Jun. 16, 2016

(54) DISPLAY PANEL WITH TOUCH FUNCTION AND MANUFACTURE METHOD THEREOF

(71) Applicant: Shenzhen China Star Optoelectronics Technology Co. Ltd., Shenzhen, Guangdong (CN)

(72) Inventors: Man LI, Shenzhen, Guangdong (CN); Yao-li HUANG, Shenzhen, Guangdong (CN)

(73) Assignee: Shenzhen China Star Optoelectronics Technology Co. Ltd., Shenzhen, Guangdong (CN)

(21) Appl. No.: 14/433,636

(22) PCT Filed: Dec. 30, 2014
(86) PCT No.: PCT/CN2014/095560

§ 371 Date: Apr. 3, 2015

(30) Foreign Application Priority Data
Dec. 10, 2014 (CN) 2014107585891

(51) Int. Cl. G06F 3/041; G06F 3/044

(52) U.S. Cl. CPC G06F 3/0416; G06F 3/0412; G06F 3/044; G06F 2203/04112; G06F 2203/04103

(57) ABSTRACT

The present invention discloses a display panel with touch function and a manufacture method thereof. The display panel comprises a first substrate and a second substrate, which are oppositely located, and a liquid crystal layer sandwiched between the first substrate and the second substrate, wherein the display panel further comprises a transparent cover plate oppositely located with a surface of the second substrate away from the first substrate, a first touch control electrode formed on a surface of the first substrate away from the second substrate and a second touch control electrode formed on a surface of the transparent cover plate close to the first substrate. With the aforesaid arrangement, the present invention can make the display panel with touch function more lightening, which is beneficial to lighten the electronic device utilizing the display panel, such as a cellular phone.

### FIELD OF THE INVENTION

The present invention relates to a display panel technology field, and more particularly to a display panel with touch function and a manufacture method thereof.

### BACKGROUND OF THE INVENTION

With the competitions in the smart phone market gets more intense, the structure design for lightening the small electronic products, such as cellular phones has become the one major point which the cellular makers pay lots of attentions. One extremely important solution of lightening the display screen of the cellular phone is to employ the full fit skill to replace the previous frame attachment skill.

The full fit skill comprises the OGS skill lead by the touch screen makers and On-Cell and In-Cell technology lead by the display screen makers. As comparing the OGS skill and the On-Cell technology with the traditional frame attachment skill, one sheet of glass and one attachment can be omitted which can make the touch screen thinner and make the cost lower. However, the former requires manufacturing a touch sensor plate on a protective glass (i.e. transparent cover plate) and the latter needs the touch sensor plate formed between the CF glass substrate and the polarizer. The thickness of the touch sensor plate is larger which restrict the lightening of the display screen. The In-Cell technology can achieve the objective of lightening in advance by embedding the touch sensor inside the LCD but issues of the internal noise interference and the production yield remain.

Consequently, there is a need to provide a display panel with touch function and a manufacture method thereof for solving the aforesaid technical issues.

### SUMMARY OF THE INVENTION

A technical issue that the present invention is mainly to solve is to provide a display panel with touch function and a manufacture method thereof, which can make the display panel with touch function more lightening, which is beneficial to lighten the electronic device utilizing the display panel, such as a cellular phone.

For solving the aforesaid technical issue, the technical solution employed by the present invention is: providing a display panel with touch function, wherein the display panel comprises a first substrate and a second substrate, which are oppositely located, and a liquid crystal layer sandwiched between the first substrate and the second substrate, wherein the display panel further comprises a transparent cover plate oppositely located with a surface of the second substrate away from the first substrate, a first touch control electrode formed on a surface of the first substrate away from the second substrate and a second touch control electrode formed on a surface of the transparent cover plate close to the first substrate, and the first touch control electrode is a sensing electrode, and the second touch control electrode is a driving electrode, and the first substrate is a CF substrate, and the second substrate is a TFT substrate.

The first lens panel comprises a first transparent substrate, a second transparent substrate which are oppositely positioned, and a first liquid crystal layer packaged between the first transparent substrate and the second transparent substrate, and the second lens panel comprises a third transparent substrate, a fourth transparent substrate which are oppositely positioned, and a second liquid crystal layer packaged between the third transparent substrate and the fourth transparent substrate, and the first transparent substrate is constructed by connecting a plurality of first curved structures which sections along the predetermined direction are arches, and the third transparent substrate is constructed by connecting a plurality of second curved structures which sections along the predetermined direction are arches, and the first curved structure and the second curved structure stagger along the predetermined direction, and both the first liquid crystal layer and the second liquid crystal layer comprise a plurality of liquid crystal molecules, and a first axis refractive index of the liquid crystal molecules is larger than refractive indexes of the first transparent substrate and the third transparent substrate, and a second axis refractive index of the liquid crystal molecules is equal to the refractive indexes of the first transparent substrate and the third transparent substrate.

Widths of the first curved structure and the second curved structure along the predetermined direction are equal, and a staggered distance of the first curved structure and the second curved structure along the predetermined direction is a half of the width.

The control unit controls the first display panel to be in the display panel state, and the first lens unit of the first lens panel to be in the non focused state, or controls the first display panel to be in the transparent state, and the second display panel to be in the display panel state under 2D mode, and both the first lens unit of the first lens panel and the second lens unit of the second lens panel are in the non focused state.

The control unit is employed to control the liquid crystal molecules to twist, wherein as a first axis of the liquid crystal molecules is twisted to be parallel with the first display panel, the corresponding first lens unit or the corresponding second lens unit is in the focused state, and as the first axis of the liquid crystal molecules is twisted to be perpendicular with the first display panel, the corresponding first lens unit or the corresponding second lens unit is in the non focused state.

The display panel further comprises a first cell and a second cell, and the first cell is positioned between the first lens panel and the first display panel, and the second cell is positioned between the second lens panel and the second display panel, and the control unit respectively controls polarization states of polarized lights entering the first lens unit and the second lens unit by controlling the first cell and the second cell and accordingly, to control the first lens unit and the second lens unit to switch between the focused state and the non focused state.

For solving the aforesaid technical issue, another technical solution employed by the present invention is: providing a display panel switchable between 2D and 3D modes, wherein the display panel comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction.

Both the first substrate and the transparent cover plate are glass material, and the first touch control electrode and the second touch control electrode are ITO material.

The display panel further comprises a first polarizer positioned between the first substrate and the transparent cover plate.

The display panel further comprises an adhesive layer between the first polarizer and the transparent cover plate, and the first polarizer is adhered to the transparent cover plate with the adhesive layer.

The display panel further comprises a second polarizer located on a surface of the second substrate away from the first substrate.

For solving the aforesaid technical issue, another technical solution employed by the present invention is: providing a display panel with touch function, wherein the display panel comprises a first substrate and a second substrate, which are oppositely located, and a liquid crystal layer sandwiched between the first substrate and the second substrate, wherein the display panel further comprises a transparent cover plate oppositely located with a surface of the second substrate away from the first substrate, a first touch control electrode formed on a surface of the first substrate away from the second substrate and a second touch control electrode formed on a surface of the transparent cover plate close to the first substrate.

The first touch control electrode is a sensing electrode, and the second touch control electrode is a driving electrode.

Both the first substrate and the transparent cover plate are glass material, and the first touch control electrode and the second touch control electrode are ITO material.

The display panel further comprises a first polarizer positioned between the first substrate and the transparent cover plate.

The display panel further comprises an adhesive layer between the first polarizer and the transparent cover plate, and the first polarizer is adhered to the transparent cover plate with the adhesive layer.

The first substrate is a CF substrate, and the second substrate is a TFT substrate.

The display panel further comprises a second polarizer located on a surface of the second substrate away from the first substrate.

For solving the aforesaid technical issue, another technical solution employed by the present invention is: providing a manufacture method of a display panel with touch function, wherein the manufacture method comprises: oppositely assembling a first substrate and a second substrate, wherein a first touch control electrode is formed on a surface of the first substrate away from the second substrate; coating an adhesive layer on the surface of the first substrate away from the second substrate; adhering a transparent cover plate on the adhesive layer, wherein a second touch control electrode is formed on a surface of the transparent cover plate close to the first substrate.

Before the step of oppositely assembling the first substrate and the second substrate, the manufacture method further comprises steps of: manufacturing the first touch control electrode of ITO material on the surface of the first substrate away from the second substrate by photolithograph skill or photo process; manufacturing the second touch control electrode of ITO material on the surface of the transparent cover plate close to the first substrate by photolithograph skill or photo process.

The step of oppositely assembling the first substrate and the second substrate further comprises a step of: adhering a first polarizer on the surface of the first substrate away from the second substrate; the step of coating the adhesive layer on the surface of the first substrate away from the second substrate comprises: coating the adhesive layer on a surface of the first polarizer away from the first substrate.

The benefits of the present invention are: different from prior arts, the present invention forms the first touch control electrode on the surface of the first substrate away from the second substrate, and forms the second touch control electrode on the surface of the transparent cover plate close to the first substrate. Accordingly, the display panel with touch function according to the present invention can make the display panel with touch function more lightening, which is beneficial to lighten the electronic device utilizing the display panel, such as a cellular phone.

### BRIEF DESCRIPTION OF THE DRAWINGS

FIG. 1 is a structural diagram of a display panel with touch function according to the preferred embodiment the present invention;

FIG. 2 is a flowchart of a manufacture method of a display panel with touch function according to the preferred embodiment of the present invention.

### DETAILED DESCRIPTION OF PREFERRED EMBODIMENTS

The present invention will be further described in detail with the accompanying drawings and the specific embodiments.

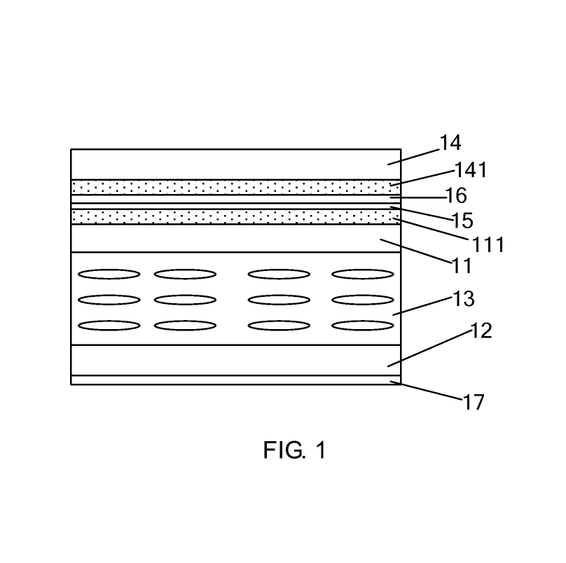

Please refer to FIG. 1. FIG. 1 is a structural diagram of a display panel with touch function according to the preferred embodiment the present invention. In this embodiment, the display panel comprises a first substrate 11 and a second substrate 12, which are oppositely located, and a liquid crystal layer 13 sandwiched between the first substrate 11 and the second substrate 12, wherein the display panel further comprises a transparent cover plate 14 oppositely located with a surface of the second substrate 12 away from the first substrate 11, a first touch control electrode 111 formed on a surface of the first substrate 11 away from the second substrate 12 and a second touch control electrode 141 formed on a surface of the transparent cover plate 14 close to the first substrate 11.

Preferably, the first touch control electrode 111 is a sensing electrode, and the second touch control electrode 141 is a driving electrode. In other embodiments, the first touch control electrode 111 can be the driving electrode, and the second touch control electrode 141 can be the sensing electrode.

Preferably, the first touch control electrode 111 is an electrode pattern and structure formed on the surface of the first substrate 11 away from the second substrate 12. The second touch control electrode 141 is an electrode pattern and structure formed on the surface of the transparent cover plate 14 close to the first substrate 11. The electrode pattern and structure corresponds to the touchable control points.

Preferably, both the first substrate 11 and the transparent cover plate 14 are glass material, and the first touch control electrode 111 and the second touch control electrode 141 are ITO material. The formations of the first touch control electrode 111 and the second touch control electrode 141 are: manufacturing the first touch control electrode 111 of ITO material on the surface of the first substrate 11 away from the second substrate 12 by photolithograph skill or photo process; manufacturing the second touch control electrode 141 of ITO material on the surface of the transparent cover plate 14 close to the first substrate 11 by photolithograph skill or photo process.

Preferably, the display panel further comprises a first polarizer 15 positioned between the first substrate 11 and the transparent cover plate 14.

Preferably, the display panel further comprises an adhesive layer 16 between the first polarizer 15 and the transparent cover plate 14, and the first polarizer 15 is adhered to the transparent cover plate 14 with the adhesive layer 16.

Preferably, the first substrate 11 is a CF substrate, and the second substrate 12 is a TFT substrate. In other embodiments, the first substrate 11 can be the TFT substrate, and the second substrate 12 can be the CF substrate.

Preferably, the display panel further comprises a second polarizer 17 located on a surface of the second substrate 12 away from the first substrate 11.

Preferably, the display panel further comprises other structures which the other present TFT display panels have. The repeated description is omitted here.

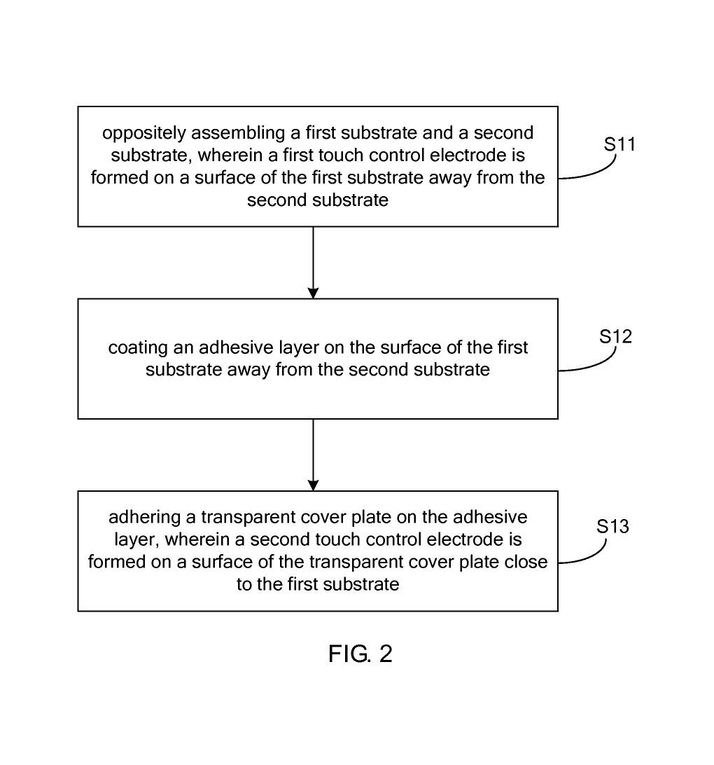

Please refer to FIG. 2. FIG. 2 is a flowchart of a manufacture method of a display panel with touch function according to the preferred embodiment of the present invention. In this embodiment, the manufacture method of a display panel with touch function comprises steps of:

Step S11, oppositely assembling a first substrate and a second substrate, wherein a first touch control electrode is formed on a surface of the first substrate away from the second substrate.

In the Step S11, before the step of oppositely assembling the first substrate and the second substrate, the manufacture method further comprises steps of: manufacturing the first touch control electrode of ITO material on the surface of the first substrate away from the second substrate by photolithograph skill or photo process; manufacturing the second touch control electrode of ITO material on the surface of the transparent cover plate close to the first substrate by photolithograph skill or photo process. The step of oppositely assembling the first substrate and the second substrate further comprises a step of: adhering a first polarizer on the surface of the first substrate away from the second substrate. The step of oppositely assembling the first substrate and the second substrate can further comprise a step of packaging a liquid crystal layer between the first substrate and the second substrate.

Step S12, coating an adhesive layer on the surface of the first substrate away from the second substrate.

In the Step S12, the step of coating the adhesive layer on the surface of the first substrate away from the second substrate comprises: coating the adhesive layer on a surface of the first polarizer away from the first substrate.

Step S13, adhering a transparent cover plate on the adhesive layer, wherein a second touch control electrode is formed on a surface of the transparent cover plate close to the first substrate.

Preferably, the manufacture method can further comprise: locating a second polarizer on a surface of the second substrate away from the first substrate.

Different from prior arts, the present invention forms the first touch control electrode 111 on the surface of the first substrate 11 away from the second substrate 12, and forms the second touch control electrode 141 on the surface of the transparent cover plate 14 close to the first substrate 11.

Accordingly, the display panel with touch function according to the present invention can make the display panel with touch function more lightening and simplify the manufacture process, which is beneficial to lighten the electronic device utilizing the display panel, such as a cellular phone; meanwhile, the second touch control electrode 141 is formed on the transparent cover plate 14, which is closer to the finger of touch control and can sense the touch signals more easily to promote the sensibility of the touch control.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A display panel with touch function, wherein the display panel comprises a first substrate and a second substrate, which are oppositely located, and a liquid crystal layer sandwiched between the first substrate and the second substrate, wherein the display panel further comprises a transparent cover plate oppositely located with a surface of the second substrate away from the first substrate, a first touch control electrode formed on a surface of the first substrate away from the second substrate and a second touch control electrode formed on a surface of the transparent cover plate close to the first substrate, and the first touch control electrode is a sensing electrode, and the second touch control electrode is a driving electrode, and the first substrate is a CF substrate, and the second substrate is a TFT substrate.

2. The display panel according to claim 1, wherein both the first substrate and the transparent cover plate are glass material, and the first touch control electrode and the second touch control electrode are ITO material.

3. The display panel according to claim 1, wherein the display panel further comprises a first polarizer positioned between the first substrate and the transparent cover plate.

4. The display panel according to claim 3, wherein the display panel further comprises an adhesive layer between the first polarizer and the transparent cover plate, and the first polarizer is adhered to the transparent cover plate with the adhesive layer.

5. The display panel according to claim 1, wherein the display panel further comprises a second polarizer located on a surface of the second substrate away from the first substrate.

6. A display panel with touch function, wherein the display panel comprises a first substrate and a second substrate, which are oppositely located, and a liquid crystal layer sandwiched between the first substrate and the second substrate, wherein the display panel further comprises a transparent cover plate oppositely located with a surface of the second substrate away from the first substrate, a first touch control electrode formed on a surface of the first substrate away from the second substrate and a second touch control electrode formed on a surface of the transparent cover plate close to the first substrate.

7. The display panel according to claim 6, wherein the first touch control electrode is a sensing electrode, and the second touch control electrode is a driving electrode.

8. The display panel according to claim 6, wherein both the first substrate and the transparent cover plate are glass material, and the first touch control electrode and the second touch control electrode are ITO material.

9. The display panel according to claim 6, wherein the display panel further comprises a first polarizer positioned between the first substrate and the transparent cover plate.

10. The display panel according to claim 9, wherein the display panel further comprises an adhesive layer between the first polarizer and the transparent cover plate, and the first polarizer is adhered to the transparent cover plate with the adhesive layer.

11. The display panel according to claim 6, wherein the first substrate is a CF substrate, and the second substrate is a TFT substrate.

12. The display panel according to claim 6, wherein the display panel further comprises a second polarizer located on a surface of the second substrate away from the first substrate.

13. A manufacture method of a display panel with touch function, wherein the manufacture method comprises:
oppositely assembling a first substrate and a second substrate, wherein a first touch control electrode is formed on a surface of the first substrate away from the second substrate;
coating an adhesive layer on the surface of the first substrate away from the second substrate;
adhering a transparent cover plate on the adhesive layer, wherein a second touch control electrode is formed on a surface of the transparent cover plate close to the first substrate.

14. The manufacture method according to claim 13, wherein before the step of oppositely assembling the first substrate and the second substrate, the manufacture method further comprises steps of:
manufacturing the first touch control electrode of ITO material on the surface of the first substrate away from the second substrate by photolithograph skill or photo process;
manufacturing the second touch control electrode of ITO material on the surface of the transparent cover plate close to the first substrate by photolithograph skill or photo process.

15. The manufacture method according to claim 13, wherein the step of oppositely assembling the first substrate and the second substrate further comprises a step of:
adhering a first polarizer on the surface of the first substrate away from the second substrate;
the step of coating the adhesive layer on the surface of the first substrate away from the second substrate comprises:
coating the adhesive layer on a surface of the first polarizer away from the first substrate.
